(19) United States
(12) Patent Application Publication
(10) Pub. No.: US 2002/0109596 A1
(43) Pub. Date: Aug. 15, 2002

(54) Interactive jewelry

(76) Inventors: Richard S. Phillips, Ballwin, MO (US); Susan L. Butler, Wildwood, MO (US)

Correspondence Address: HAVERSTOCK, GARRETT & ROBERTS, 611 OLIVE STREET, SUITE 1610, ST. LOUIS, MO, 63101, US

(21) Appl. No.: 09/782,885

(22) Filed: Feb. 13, 2001

(51) Int. Cl. G08B 23/00

(52) U.S. Cl. 340/573.1; 340/539; 340/540

(57) ABSTRACT

Interactive jewelry, watches and accessories which when placed in proximity to other pieces of like-interactive jewelry, watches or accessories will respond with visual, audible, electromagnetic and/or mechanical response/notification. The jewelry, watches and accessories can be comprised of a decorative portion and a functional portion. The interactive jewelry, watches and accessories can include, but not be limited to, the following: rings, bracelets, anklets, necklaces, brooches, earrings, pins, watches, key-chains, hairpieces, body piercing components, headbands, writing utensils, book-bag, binders, hats, purses, glasses, or other article of clothing, or other static objects, or other portable objects; interactive jewelry, watches and accessories can also be applied directly to the skin of the wearer or other surface with an adhesive, Velcro or other attaching agents.

### STATEMENT REGARDING FEDERALLY SPONSORED RESEARCH & DEVELOPMENT

This invention was not made under any Government contract nor with any Government funds and was not Federally sponsored in any other way.

### CROSS REFERENCE TO RELATED APPLICATIONS

(if applicable)

This is an original application.

### BACKGROUND OF THE INVENTION

Most conventional jewelry items have no interaction with other jewelry. They are simply objects of ornamentation from simple dime store rings to exquisite masterpieces of artistic creation and value.

Crude attempts have been made to develop interactive jewelry. For example, in U.S. Pat. No. 6,050,695 to Fromm, one of the jewelry items is provided with an electrical display with an open electrical circuit and requires the presence of another matching jewelry item to contact the open electrical circuit to complete the circuit and initiate the operation of the electrical display. The preferred electrical display in Fromm is a light placed under a translucent stone in a ring. The electrical contacts are either specially shaped to make a given ring only engage with a particular matching ring or are magnetic switches. We might term these “engagement rings.”

Proximity sensors are known for military operations, which interact without requiring physical contact. Proximity sensors are also known in home confinement sentenced prisoner bracelets, but those alarm in response to the absence of a signal. Other systems alarm in response to presence of a signal from a remote unit. For example in Pilney et al. U.S. Pat. No. 5,298,883 a proximity alert system for hunters is shown, which alarms if two hunters get too close to each other. However, this is a large unit not practical for jewelry.

It would be desirable to provide jewelry, watches and accessories that could interact at a close distance prior to actual contact and yet be selective as to interaction to provide wearers with enjoyment without requiring physical adjacency.

### BRIEF SUMMARY OF THE INVENTION

The invention in one exemplary embodiment is an interactive jewelry item which includes a first functional portion, which we call a TSR (transmitter, sensor, responder) unit, including a power source, a proximity sensor, a transmitter, and a responder. The sensor is for detecting a like second functional portion or TSR in proximity to the first TSR and for generating a mutual response between the TSRs when the jewelry items are proximate, and thus before they are physically adjacent. Unlike the “engaging rings” of the Fromm patent above, the interactive jewelry of this invention does not close any circuit when adjacent, but rather activates a response prior to adjacency, namely when the jewelry items are proximate before adjacency. An additional function could be added that would only be triggered by physical adjacency as in Fromm, but that is optional. In one exemplary embodiment, the response signal is a visual light of a desired color and the items are matching rings. In a second exemplary embodiment, at least one of the jewelry items has multiple colors and can detect which, if any, of a plurality of other TSRs are proximate to the jewelry item and respond with appropriate colors. In another exemplary embodiment, one jewelry item is a necklace and in another exemplary embodiment, a purse. The jewelry items may likewise be, by way of example and without limitation, clothing, toys, books, sports objects, bicycles, watches and accessories that can be worn, carried or otherwise attached in some manner to a person or object.

### BRIEF DESCRIPTION OF THE DRAWINGS

FIG. 1 is a perspective view of two hands, each with an exemplary interactive jewelry item ring thereon,

FIG. 2 is a perspective view of three exemplary interactive jewelry items, a purse, a ring and a necklace, with the purse and ring interacting in exemplary fashion and the necklace not responding,

FIG. 3 is a perspective view of an exemplary multi-response interactive jewelry items, one of the multiple responders being responsive with light, sound or action and the other being responsive with multicolor lights, and

FIG. 4 is a perspective view of another exemplary of multi-response interactive jewelry items, one being a watch and another a bracelet, each with a response selector.

### DETAILED DESCRIPTION OF THE INVENTION

The following special definitions are used in this specification. “Jewelry” means any holder for the TSRs that serves a similar function to jewelry, being portable and decorative. For example a child's bike, shirt, athletic item, game item, toy or the like could each be “jewelry” if it includes a TSR. “Signal” may be infrared, visible light, sound, electrical current, alphanumeric display, or any other means of communication capable of activating a device. “Thermometer” means any temperature sensing device, electronic or otherwise, not merely convention glass bulb thermometers. “Fromm system” as used herein means a system similar to that shown in U.S. Pat. No. 6,050,695 to Fromm that, unlike TSRs that are remotely activated, is not activated by proximity but instead requires adjacency, i.e. physical contact or interengagement, to cause an electrical circuit to close.

In the specific embodiment illustrated, a cylindrical decorated ring has a TSR. The “jewelry” of the invention can have a number of different shapes, sizes, colors and materials not limited in any way to the specific embodiment depicted below and can even be items not normally considered as jewelry; the “jewelry” could also include, by way of example, as an electronic display.

Referring to FIG. 1, a first exemplary interactive ring 100 is worn by a person (not shown) on a first hand 101 and a second exemplary interactive ring 102 is worn by a second person (not shown) on a second hand 103. Ring 100 has a selfpowered transmitter-sensor-responder (“TSR”) unit 104 and ring 102 has a TSR 105. When rings 100 and 102 are within a certain distance, for example two feet, of each other, TSR 104 and TSR 105 glow. The power source (not shown) for TSR 104, and for all TSRs shown below is a battery, although a power cord to another source of electricity, or another electrical power source such as a solar panel, could be substituted.

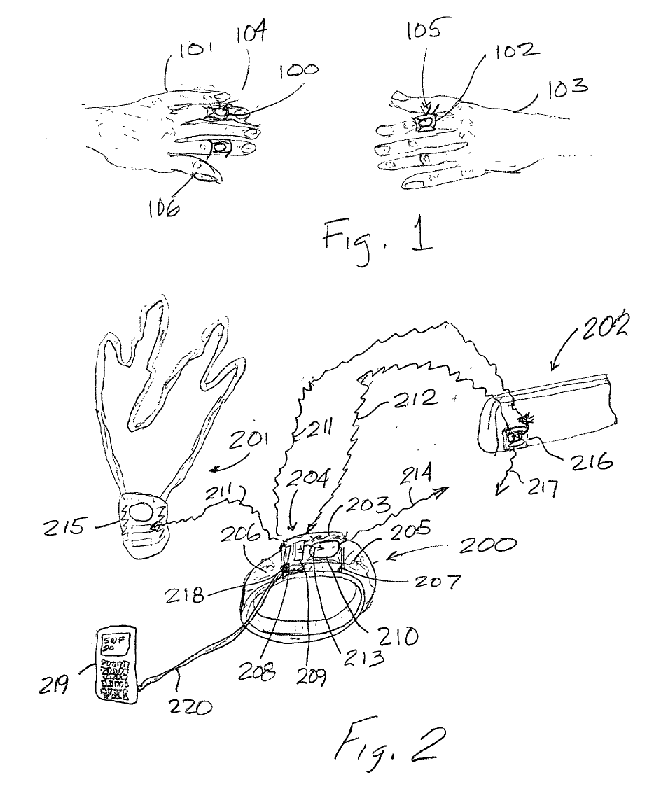

Referring to FIG. 2, an exemplary ring 200, similar to ring 100, is placed near a necklace 201 and a purse 202. Ring 200 has a housing 207 attaching a TSR 204 to ring 200. Ring 200 also has decorative art 203, 205 and 206 which can be decals, stencils, paintings, engravings or any other form of decoration desired. Ring 200, necklace 201 and purse 202 have TSR 204, 215 and 216. TSR 204 includes a transmitter 208, a sensor 209, and a responder 210. Responder 210 is a translucent globe with a light bulb, audible indicator (not shown) or LCD/LED (not shown) underneath.

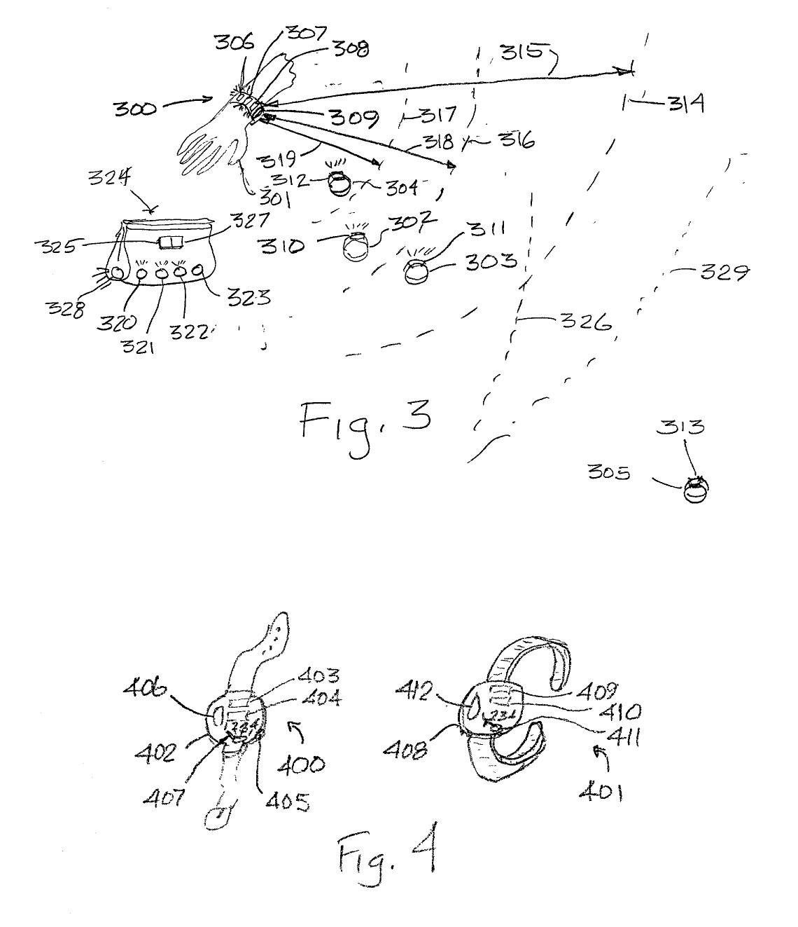

Transmitter 208 emits signals 211 to necklace 201 and purse 202 for receipt by TSR 215 and TSR 216, respectively. TSR 215 does not respond, but TSR 216 receives the signal from TSR 204 and activates responder 216 which in this example is a glowing light emitting a light signal 217. Likewise TSR 216 transmits a signal 212 which sensor 209 senses and in response to signal 212 sensor 209 triggers responder 210 to provide an audible indication (not shown), an LCDILED message (not shown) or, a a response signal 214 such as light glowing from a translucent stone 213. This results in a selective response where necklace 201 does not respond to ring 200 but purse 202 starts responding as ring 200 approaches purse 202. It is expected that kids will love this selective effect, particularly when boyfriend and girlfriend are wearing matching items such as a boy wearing ring 200 and his girlfriend carrying purse 202. Many other jewelry items could be substituted since TSR 104, 105, 204, 215 and 216 are attachable to nearly any type of item. Thus, as noted above, “jewelry” in this present application merely means an item having a TSR. While exemplary TSRs are shown in FIGS. 1-4, it will be understood that many variations can be used. This will be clearer after reviewing FIGS. 3-4, and the associated description below.

In the prior art engagement rings (Fromm), the selectivity of response was provided by specially shaped contacts, which means that physical interengagement of the rings is required. With the exemplary embodiment using proximity sensing, the selectivity must be done remotely, and this is accomplished by special signals transmitted by TSRs 204, 215 and 216. The use of signals allows a more complex interaction between ring 200, necklace 201 and purse 202. For example, ring 201 could instead activate a particular responder on necklace 201 but activate a different type of responder on purse 202.

With current and future wireless technology, a data stream could be incorporated into signals 211 and 212. Sensor 209 of TSR 204 could be programmed so as to require a particular data string to be received by sensor 209 in order to activate responder 210. Likewise, responder 210 could be programmed to respond with a data stream to produce on TSR 216 a text message or a digital image or an audio stream or video stream to provide any of a wide variety of multimedia data interaction to the ring. In the prior art device of Fromm, no such complicated signal is envisioned but rather only a go-nogo type response. This data stream interaction would allow special capabilities to the jewelry, whether done remotely as we prefer, or done via direct contact. TSR 204 has a data port 218 for this purpose. Port 218 can be connected to a personal computer or PDA 219 by a cable 220 for data entry into TSR 204. For example, the entered data might, by way of example, be the criteria “single, male, college educated, cowboy, 25 years old, looking for a single, female, college educated, doctor, 20-30 years old”. This message would then be transmitted as signal 211 to TSR 215 of necklace and TSR 216 of purse 202. In this example, TSR 215 or necklace 201 was programmed in similar fashion to TSR 204, but with the criteria “single, female 15, looking for male high school athlete 16-18” and thus does not respond since TSR 215 detects that there is no match. On the other hand, TSR 216, which has been programmed, for example, with the criteria “single, female, college educated, doctor, 23 years old looking for a single, male, college educated, cowboy, 20-30 years old”. TSR 204 and 216 thus interpret signals 211 and 212 to indicate a match and TSR 204 and 216 glow in response to the match. In this way we have a means for pre-qualification of prospective dates, without need for dumb questions, in minimal time. Or, on a simpler scale, TSR 204 simply might be encoded with “square dancer”, TSR 215 with “sailor” and TSR 216 also encoded “square dancer”. TSR 204 and TSR 216 would glow in response to the match, but TSR 215 would not glow, indicating no other sailor TSR within range.

This interactive jewelry could thus serve to facilitate more reliable dating. Alternative input devices such as PDA 219 could be used to enhance this effect. TSR 204 could instead come pre-programmed, if desired, so that a religious group or activist group could, for example, give interactive jewelry to its members so that they could recognize each other more easily and reliably. This would allow the jewelry to serve an identification function, which might prove useful as a ticket at a convention or the like, a gatekeeper merely having to check to see if the person's jewelry item glows or otherwise responds upon attempted admission. This would also work for amusement parks, sports events, school security and the like.

Referring to FIG. 3, a multi-response bracelet 300 on a hand 301 is shown spaced from four interactive rings 302, 303, 304 and 305. In this exemplary embodiment, bracelet 300 has a responder 306. Responder 306 is configured to respond to TSRs like 310 of ring 302. Responder 306 responds if associated TSRs 310-313 on rings 302-305, respectively, is within a sphere 314 having a radius 315 of some predetermined length centered on bracelet 300, for example 15 feet. Ring 305 is outside of sphere 314 and thus TSR 313 does not activate responder 306 on bracelet 300 or vice versa. Responder 306 would preferably be a TSRs also, so that TSRs 310313 on rings 302-305 are activated to provide a response, such as a light glow, when TSRs 310-313 are within sphere 314. Multiple responders could be integral in a single responder, such as being different colored bulbs under portions of a single translucent jewelry stone. Responder 306 could be a TSR that only responds when all four TSRs 310-313 are not within sphere 314, thus indicating absence rather than presence. In fact, the responder could be configured to respond to absence, rather than presence, of rings 302-305, respectively. This would be useful for activating an alarm if a ring is outside sphere 314 and identifying which ring caused the alarm. That embodiment is somewhat analogous to prisoner security bands but in relation to jewelry.

Another four responders 320-323 are shown on a purse 324 with a sensor 325 and transmitter 327 and are of stepped signal strength and/or frequency response and are configured so that if one TSR 310-313 is within a certain preset sphere 326 about purse 325, only responder 320 activates. If two of TSRs 310-313 are within sphere 326, two responders 320 and 321 activate. If three of TSRs 310-313 are within sphere 326, as is shown in FIG. 3, three of responders 320-322 activate. If all four TSRs 310-313 are in sphere 326, all four responders 320-323 activate. This would be quite useful for a mother (not shown) keeping track of her kids (not shown) and for the kids, from the response on their respective one of TSRs 310-313 to know their mother is close by. The mother would put one ring 302-305 on each kid and the number of lights on purse 324 would show how many of those kids are within a preset distance of the mother.

As an added feature, a buzzer, beeper and/or visual indicator could be activated if less than all the rings 302-305 are within sphere 326. This would alert the mother that one or more rings 302-305 is/are too far away, so that the mother can check purse 325 to see the how many kids are close by and how many are not and which ones are not within spheres 314 or 316.

The responders 306 or 320-323 could alternatively be set so that each responder measures the presence or absence of all the rings 302-305 within a respective sphere 317, 316, 314 and 329. Alternatively, the responders could be set to measure the presence of a given number of rings in an annulus between spheres, such as between sphere 317 and sphere 314, which in FIG. 3 would be rings 302 and 303.

FIG. 4 is a perspective view of another multi-response jewelry item pair including an exemplary wristwatch 400 and an exemplary bracelet 401. Wristwatch 400 has a watch body 402 that includes a transmitter 403, a sensor 404, a battery 405, a responder 406 and a response selector 407. In similar fashion, bracelet 401 has a bracelet body 408 which includes a transmitter 409, a sensor 410, a battery (not shown), a responder 411 and a response selector 412. The response selections for selector 412 could include, but not be limited to: temperature measured by either watch 400 or bracelet 401 or temperature of both watch 401 or bracelet 402, or the temperature of the person (not shown) wearing watch 401 or bracelet 402. In this exemplary embodiment, watch 400 and bracelet 401 have conditions that are set to various values. Watch 400 has Condition #1 set to “5” whereas bracelet 401 has Condition #1 set to “7”. With this combination of “5” and “7”, both devices are, by way of example, set to react by flashing a red light at 3 flashes per second. Other combinations would produce different lights, action, sound, text message or other desired output. Small, commonly available or custom designed microchips can be used to provide the desired signal transmission, signal sensing, responder activation and response selection. Common wafer type watch batteries are used in the exemplary embodiments, but other power sources will also work. When items have temperature-sensing abilities, a common digital thermometer device (not shown) is used. For example, the digital thermometer can be used to measure the wearer's (and/or the ambient) temperature. The reading from the digital thermometer then serves as input to the transmitter and/or sensor in determining the action performed by the TSR (including, but not limited to flashing a light, setting a display, causing a vibration, etc.).

The combinations of measurements, codes, response selections and signals, are thus seen to be possible in a myriad variety of ways, depending on what is needed or desired in a given situation. While the “jewelry” is depicted in the exemplary embodiments as jewelry and accessories, it will be apparent that the concepts disclosed are applicable to a wide variety of devices where proximity sensing is useful. In simple versions, the system can be a simple proximity lighting activation as in FIG. 1. In more complex versions, circuitry could be adapted to sense a variety of parameters. As miniaturization of circuitry continues, and capabilities increase, such parameters as temperature, conductivity or resistance, visual image match, and numerous other parameters might be set as the criteria for the responders to respond. While the response is depicted in terms of glowing lights in FIGS. 1-4, the response could be a more complex response such as an image display, a data display or other similar display. The interactive jewelry is thus capable of a wide variety of proximity sensing and response, limited in large sense only by the abilities of the circuit builder, which are becoming more and more sophisticated with every passing year. The invention is thus forward looking in encompassing future interactive jewelry which uses the basic concepts disclosed herein but merely add new circuitry to produce new or more detailed sensing, transmitting and responding capabilities.

There could be added to any of the interactive jewelry noted above a Fromm system, although the TSRs are more versatile in application due to the variety of signals which can be transmitted.

While there have been described above the principles of this invention in connection with specific exemplary embodiments, it should be clearly understood that this description is made only by way of example, and not as a limitation to the scope and specific embodiment of the invention.

What is claimed is:

1. Interactive jewelry, comprising: a first interactive jewelry item having a first functional portion, said first functional portion including a first transmitter, a first sensor, a first responder and a first power supply, said first sensor configured to activate said first responder in response to receipt of a first signal of a predetermined type indicative of proximity of a predetermined type of second interactive jewelry item within a first predetermined range of said first item, said first range being greater than adjacency.

2. Interactive jewelry in accordance with claim 1 further comprising: a second interactive jewelry item, having a second functional portion including a second transmitter, a second sensor, a second responder, and a second power supply, said transmitter capable of transmitting said first signal, and said second sensor configured to activate said second responder in response to receipt of a second signal of a predetermined type indicative of the proximity of said first and second items within said first range, said range being greater than adjacency.

3. Interactive jewelry in accordance with claim 2 wherein said first functional portion includes a data storage device and said second functional portion includes a data storage device, and said first and second transmitters are configured to transmit certain data from said storage device and said first and second sensors, respectively, are operatively connected to said first and second data storage devices and are configured to receive said transmitted certain data and determine if said certain data satisfies certain criteria and to generate activation signals to said first and second responders if said certain data satisfies said certain criteria.

4. Interactive jewelry in accordance with claim 3 wherein said certain data is the same for said first and second functional portions.

5. Interactive jewelry in accordance with claim 3 wherein said certain data for said first functional portion is different from said certain data for said second functional portion.

6. Interactive jewelry in accordance with claim 3 wherein said certain data is changeable and said first functional portion includes an input device for allowing change of said certain data.

7. Interactive jewelry in accordance with claim 6 wherein said first and second functional portions each have an input device that can only be operated by a special input device, so that entry of data into said first and functional portion can be securely controlled.

8. Interactive jewelry in accordance with claim 2 further comprising a third responder on said first item, said responder configured to respond to a third interactive jewelry item having a transmitter, sensor, responder and power source.

9. Interactive jewelry in accordance with claim 8 further comprising a fourth responder on said first item, said responder configured to respond to a fourth interactive jewelry item having a transmitter, sensor, responder and power source.

10. Interactive jewelry in accordance with claim 9 wherein said third and fourth responders are integral with said first responder.

11. Interactive jewelry in accordance with claim 10 wherein said first, third and fourth responders are also integral with said first transmitter.

12. Interactive jewelry in accordance with claim 10 wherein said first, third and fourth responders are also integral with said first sensor.

13. Interactive jewelry in accordance with claim 9 wherein said first, third and fourth responders are also integral with said first sensor.

14. Interactive jewelry in accordance with claim 1 wherein said first interactive jewelry item includes a response selector to vary the type of response given to a signal input.

15. Interactive jewelry in accordance with claim 2 wherein said first and second items each have an optional response selector to vary the type of response to a signal input.

16. Interactive jewelry in accordance with claim 1 further comprising a thermometer held by said first item and operatively connected to said functional portion to generate a signal from said first transmitter indicative of a temperature measured by said thermometer.

17. Interactive jewelry in accordance with claim 1 wherein said first transmitter and first sensor are integral with each other.

18. Interactive jewelry in accordance with claim 1 wherein said first transmitter, first sensor and first responder are integral with each other.

19. Interactive jewelry in accordance with claim 1 further comprising a first data storage device in said first functional portion operatively connected to said first sensor; a first data entry port on said functional portion for receiving response conditions from a data entry device and entering said response conditions into said first data storage device; and a first data analyzer in said first sensor to determine if a signal received by said first sensor matches said entered response conditions and, if yes, to activate said first responder.

20. Interactive jewelry in accordance with claim 19 further comprising a second data storage device in said second functional portion operatively connected to said second sensor; a second data entry port on said second functional portion for receiving response conditions from the data entry device and entering said response conditions into said second data storage device; and a second data analyzer in said second sensor to determine if a signal received by said second sensor matches said entered response conditions and, if yes, to activate said second responder.

21. Interactive jewelry in accordance with claim 19, wherein said first data entry port is configured to directly contact said second data entry port, and said first and second functional portions are the remote entry device for each other.

22. Interactive jewelry in accordance with claim 1 further comprising a data storage device operatively connected to said first functional portion.

23. Interactive jewelry in accordance with claim 1 further comprising a Fromm system operatively connected to said first functional portion in addition to said first functional portion.
